(19) United States
(12) Patent Application Publication
(10) Pub. No.: US 2018/0236499 A1
(43) Pub. Date: Aug. 23, 2018

(54) RINSING MACHINE FOR DISPLAY PANEL AND RINSING METHOD THEREOF

(71) Applicants: Boe Technology Group Co., Ltd., Beijing (CN); Chengdu Boe Optoelectronics Technology Co., Ltd., Sichuan Province (CN)

(72) Inventors: Junneng DENG, Beijing (CN); Tao DENG, Beijing (CN)

(21) Appl. No.: 15/709,803

(22) Filed: Sep. 20, 2017

(30) Foreign Application Priority Data
Feb. 22, 2017 (CN) 201710096079.6

(51) Int. Cl. B08B 3/04; B08B 3/14; B08B 3/08; B08B 3/10; B01D 61/14; B01D 71/68

(52) U.S. Cl. CPC B08B 3/048; B08B 3/14; B08B 3/08; B01D 71/68; B08B 3/045; B01D 61/147; B08B 3/104

(57) ABSTRACT

A rinsing machine for cleaning a display panel, including a main tank body, a spillover slot at the periphery of upper edges of the main tank body, a stirrer in the main tank body, and a rinsing liquid storage slot for storing rinsing liquid used for supplementing the rinsing liquid in the main tank body is disclosed. The rinsing liquid storage slot is communicated with the main tank body via a rinsing liquid supplement valve. The main tank body is provided with a discharge port which is capable of being opened and closed at the bottom of the main tank body. A rinsing method by means of the rinsing machine is also disclosed.

### RELATED APPLICATION

The present application claims the benefit of Chinese Patent Application No. 201710096079.6, filed on Feb. 22, 2017, the entire disclosure of which is incorporated herein by reference.

### FIELD OF THE DISCLOSURE

The present disclosure relates to the field of rinsing a display panel, and particularly to a rinsing machine for a display panel and rinsing method thereof.

### BACKGROUND

During the manufacturing of a display panel, many impurities or foreign matters tend to be left on the display panel. The impurities comprise organic impurities, solid impurities such as glass splinters and residual gum impurities. Therefore, during the manufacturing of a display panel, it is required to clean the display panel in order to remove those substances left thereon. In the prior art, the display panel is cleaned in a tank-type cleaning machine having a rinsing tank. A rinsing liquid in the rinsing tank is pure detergent or a mixed liquid of detergent and deionized water in a certain proportion. Organic foreign matters are usually removed by means of emulsification by the detergent.

The tank-type cleaning machine has a good cleaning efficiency for organic impurities that are less adhesive and solid impurities such as glass splinters, and the cleaning efficiency is in direct proportion to a rinsing liquid circulation rate, replacement frequency, detergent consumption, etc. Because of the structure of the tank-type cleaning machine and self-circulation of the rinsing liquid during the rinsing process, the efficiency of cleaning and removing residual gum impurities can only be improved by such measures as increasing the rinsing liquid circulation and replacing the rinsing liquid completely, which will, however, lead to increased energy consumption, reduced production capacity and waste of detergent and deionized water (or ultra-pure water) and the like.

### SUMMARY

The present application provides an improved rinsing machine and corresponding rinsing method so as to satisfy requirements.

In an aspect, there is provided a rinsing machine for cleaning a display panel, comprising a main tank body, a spillover slot at the periphery of upper edges of the main tank body, a stirrer in the main tank body, and a rinsing liquid storage slot for storing rinsing liquid used for supplementing the rinsing liquid in the main tank body. The rinsing liquid storage slot is communicated with the main tank body via a rinsing liquid supplement valve, the main tank body is provided with a discharge port which is capable of being opened and closed at the bottom of the main tank body.

With such rinsing machine, on the one hand, impurities adjacent to the liquid surface can be discharged by means of spillover, and on the other hand, impurities at the bottom of the main tank body can be discharged through the discharge port at the bottom. Thus, the amount of circulated rinsing liquid can be greatly reduced, power consumption can be decreased and the cost is saved.

In some embodiments, the spillover slot is communicated with the rinsing liquid storage slot via a first filter, and the discharge port is communicated with the rinsing liquid storage slot via a second filter. The two separate filters can filter impurities of different properties, which can improve a filtering effect and enhance the service life of filter elements in filters.

In a further embodiment, the rinsing liquid storage slot is disposed at a position higher than the main tank body, the spillover slot is communicated with the rinsing liquid storage slot via a first water pump, and the discharge port is communicated with the rinsing liquid storage slot via a second water pump.

In some embodiments, the first filter and the second filter are respectively provided with a polyethersulfone (PES) filtering element, and the filtering element in the first filter has a pore diameter smaller than that of the filtering element in the second filter. Impurities at the bottom usually have a particle size larger than impurities at the top, so the pore diameter of the filtering element in the second filter may be larger.

In an embodiment, the filtering element in the first filter has a pore diameter ranging from 1 μm to 1.5 μm, and the filtering element in the second filter has a pore diameter ranging from 5 μm to 10 μm.

In some embodiments, the upper edges of the main tank body are at the same horizontal level, and each side of the upper edges is curved towards the outside of the main tank body. In this way, it is enabled that the rinsing liquid overflows steadily in all directions to thereby enhance the effect of impurity discharge.

In some embodiments, the main tank body is provided with a heater. The heater can maintain the rinsing liquid at a temperature where detergent is active.

In some embodiments, the stirrer is driven by a motor below the main tank body.

In some embodiments, the main tank body is provided at its bottom with a cylinder-driven sealing plate for sealing the discharge port.

In some embodiments, the rinsing machine is also provided with a bubbling valve. The bubbling valve can further improve the rinsing effect.

In some embodiments, the bottom of the main tank body has a tapered shape. For instance, the bottom of the main tank body can substantially have a conical shape. The main tank body having this shape may facilitate precipitation and collection of impurities.

In another aspect, there is provided a method for rinsing a display panel by the rinsing machine as provided by any of the above embodiment. The method comprises the steps of:

a) placing the display panel into the rinsing liquid in the main tank body by means of a movement mechanism for the sake of rinsing;

b) after rinsing, keeping the display panel immersed in the rinsing liquid, and turning on the rinsing liquid supplement valve so that the rinsing liquid near a liquid surface of the main tank body overflows into the spillover slot via the upper edges of the main tank body;

c) turning off the rinsing liquid supplement valve, and lifting the display panel by the movement mechanism away from the main tank body;

d) activating the stirrer to drive the rinsing liquid in centrifugal rotation for a certain time period, and then turning off the stirrer; and

e) opening the discharge port to at least partially discharge the rinsing liquid at the bottom of the main tank body, and then closing the discharge port.

In some embodiments, the method further comprises a step of keeping the rinsing liquid in the main tank body still standing for a time period after rinsing and before turning on the rinsing liquid supplement valve. Still standing may render the surface of the rinsing liquid smooth and steady, thereby facilitating discharging of impurities by way of spillover.

In some embodiments, the time period may last about 20 seconds. Of course, the time period may also be greater than 20 seconds.

In some embodiments, the method also comprises the step of enabling the rinsing liquid in the spillover slot to flow into the rinsing liquid storage slot via a first filter and enabling the rinsing liquid discharged via the discharge port to flow into the rinsing liquid storage slot via a second filter.

In some embodiments, after the step e), the method further comprises the step of supplementing the rinsing liquid in the main tank body.

By means of the above rinsing method, under the principles of still standing for spillover and centrifugal separation of impurities, impurities generated during the rinsing process can be removed by two ways, which can greatly improve the removal efficiency and reduce the amount of circulated rinsing liquid.

### BRIEF DESCRIPTION OF DRAWINGS

The drawings are included to provide further understanding to the embodiments and incorporated into the present description to constitute a part thereof. The drawings illustrate some embodiments and are used with the description to explain the principle of the present invention. Other embodiments and their expected advantages can be readily realized, which can be better understood with reference to the following detailed description. Elements in the drawings are not necessarily shown in proportion. Identical reference numerals refer to like components.

FIG. 1 illustrates the defect of a prior-art tank cleaning process;

FIG. 2 substantially shows a schematic view of a rinsing machine according to an embodiment of the present application;

FIG. 3 is a schematic view showing a display panel rinsed in a main tank body of the rinsing machine according to an embodiment of the present application;

FIG. 4 shows a detailed schematic view of upper edges of the main tank body of the rinsing machine according to an embodiment of the present application;

FIG. 5 shows a schematic working flowchart of the rinsing machine according to an embodiment of the present application; and

FIGS. 6A to 6F are views showing the status of the rinsing machine in FIG. 2 at various working stages.

### DETAILED DESCRIPTION OF EMBODIMENTS

In the detailed description below, reference can be made to the drawings, which form a part of embodiments and are shown by way of example embodiments in which the present invention can be implemented.

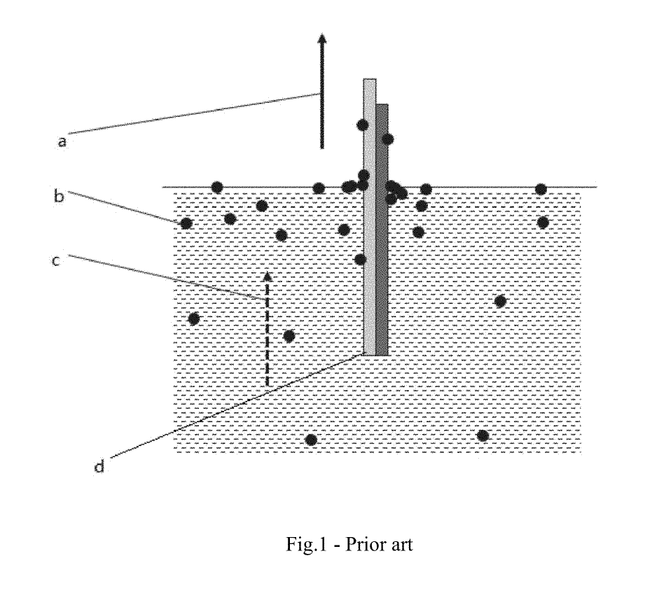

As shown in FIG. 1, in the existing tank cleaning process, for the purpose of making foreign matters flow out of the tank, the rinsing liquid overflows in one way from the bottom up, that is, the level of the rinsing liquid is kept at a spillover state. However, the residual gum leaving from the panel irregularly moves with the fluctuation of the liquid surface, under which lots of residual gum collects in its proximity. A panel, when getting out of a corresponding tank after being rinsed will have some residual gums remaining on its surface while passing through the level of the rinsing liquid. This is similar to the “tears of wine” phenomenon, and surface tension will make it worse. Therefore, during the rinsing process, even some residual gum will appear on the surface of the panel, where originally there was no residual gum at all, after experiencing a cleaning by the tank-type cleaning machine, thereby resulting in poor performance.

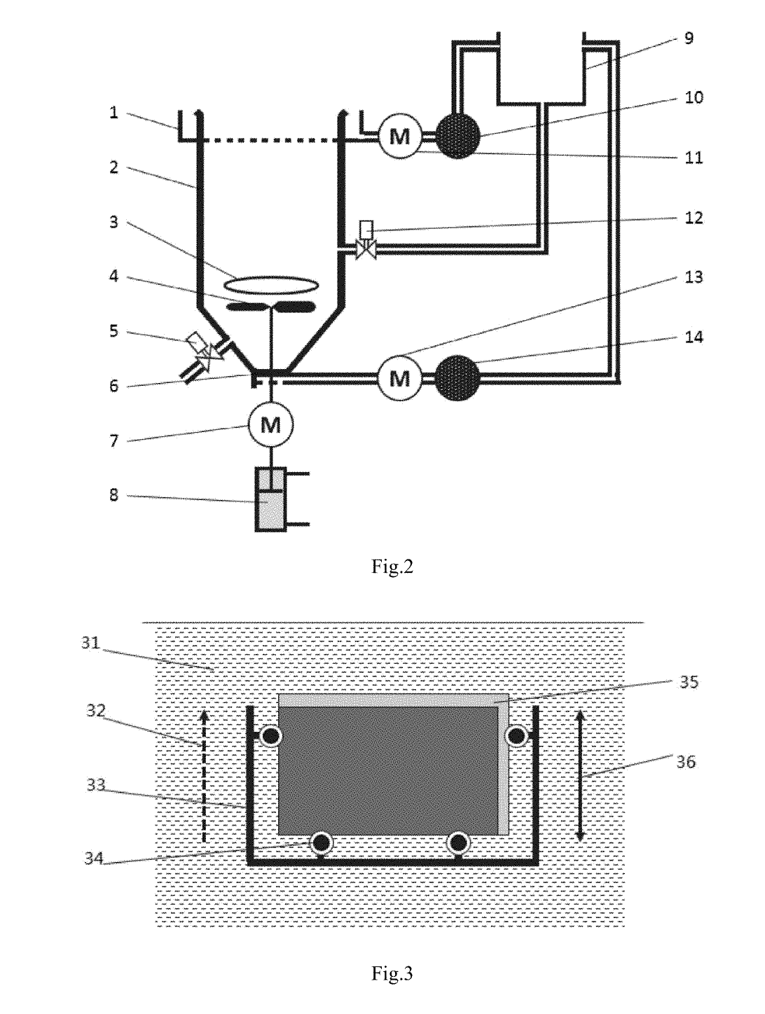

FIG. 2 substantially shows a structural schematic view of a rinsing machine according to an embodiment of the present application. As shown in FIG. 2, the rinsing machine mainly comprises a main tank body 2, a spillover slot 1, a stirrer 4 and a rinsing liquid storage slot 9. The main tank body 2 may be filled with a rinsing liquid for rinsing a display panel. The spillover slot 1 is disposed at the periphery of the upper edge of the main tank body 2 to collect the rinsing liquid overflowing from the upper edge of the main tank body 2 for the sake of recycling. The stirrer 4 is disposed at the bottom of the main tank body 2 to stir the rinsing liquid in the main tank body 2 to thereby realize centrifugal rotation of the rinsing liquid. The rinsing liquid storage slot 9 is communicated with the main tank body 2 via a rinsing liquid supplement valve to supplement the rinsing liquid in the main tank body 2. The position where the rinsing liquid storage slot 9 is communicated with the main tank body 2 is located below the upper edge of the main tank body 2, preferably located in the middle part of the main tank body 2. The main tank body 2 is also provided at its bottom with a discharge port 6 which can be opened or closed. The discharge port 6 is located at the bottom center of the main tank body 2 to discharge the rinsing liquid near the bottom center of the main tank body 2. The rinsing liquid is typically made of pure detergent or a mixed liquid of detergent and deionized water (or ultra-pure water) in a certain proportion.

On the one hand, by means of the rinsing machine, the rinsing liquid proximate to the level of the rinsing liquid can be discharged through the spillover slot 1, such that impurities floating on the liquid level can be discharged after the display panel is cleaned and before the display panel is lifted out of the main tank body (namely, by means of the so-called principle of still standing for spillover). On the other hand, with the rinsing machine, the rinsing liquid near the bottom center of the main tank body 2 can be discharged through the discharge port 6, thereby discharging impurities at the bottom of the main tank body. Further, the rinsing liquid is stirred by the stirrer 4 in the main tank body 2 to result in centrifugal rotation of the rinsing liquid. The stirrer 4 is driven by a motor 7 located under the main tank body 2. Of course, the motor 7 may be located at any position other than the one shown in FIG. 2.

By means of the centrifugal rotation, solid matters having a density larger than the rinsing liquid, such as glass splinters, can settle rapidly at the bottom of the main tank body 2. However, suspended matters having a density close to the rinsing liquid can be easily captured by solid impurities under the action of centrifugal rotation, so that the solid impurities are used as coagulation nuclei to form pellet-like impurity precipitates (i.e., the so-called centrifugal separation effect), thereby further improving the impurity removal efficiency. Thus, in the rinsing machine according to the embodiment of the present application, the impurities in the rinsing liquid can be discharged at least by two ways, namely discharged with top spillover and from the bottom, thereby fully enhancing the efficiency of removing impurities from the rinsing liquid. In comparison with the prior art method in which the amount of circulated rinsing liquid is reduced only by utilizing spillover, the embodiment in present application significantly decreases the power consumption of the motor and the consumption of detergent and deionized water (or ultra-pure water).

In some embodiments, the spillover slot 1 is communicated with the rinsing liquid storage slot 9 via a first filter 10. The first filter 10 is provided with a polyethersulfone (PES) filtering element so as to filter the impurities in the rinsing liquid. Since the impurities discharged via the spillover slot 1 are usually those having a density smaller than the rinsing liquid, such as hydrophobic organic matters or residual gum, so the filtering element of the first filter 10 typically has a smaller pore diameter, e.g., a pore diameter ranging from 1 μm to 1.5 μm.

Additionally, the discharge port 6 is communicated with the rinsing liquid storage slot 9 via a second filter 14. The second filter 14 is likewise provided with a polyethersulfone (PES) filtering element so as to filter the impurities in the rinsing liquid. Since the impurities discharged via the discharge port 6 are usually solid impurities having larger particle size, so the filtering element of the second filter 14 may have a pore diameter larger than the filtering element of the first filter 10, e.g., a pore diameter ranging from 5 μm to 10 μm.

Hence, the rinsing machine according to the embodiment of the present application can mitigate or solve the following problems of a prior art tank-type cleaning machine by adopting two filters to filter the rinsing liquid discharged in different manners: the use of only a filtering element having a larger pore diameter may have a poor filtering effect; a filtering element having a smaller pore diameter may be easily blocked; and the use of two types of serially connected filtering elements having a larger pore diameter and a smaller pore diameter may result in increased maintenance costs and heavy motor load.

In an example, the rinsing liquid discharged via the spillover slot 1 and the discharge port 6 can flow into the main tank body 2 after passing through the first filter 10 and the second filter 14 for direct recycling. In another example (as shown in FIG. 2), the spillover slot 1 and the discharge port 6 can be communicated with the rinsing liquid storage slot 9 respectively via the first filter 10 and the second filter 14, and the rinsing liquid storage slot 9 supplements the rinsing liquid to the main tank body 2.

As shown in FIG. 2, the rinsing liquid storage slot 9 can be disposed at a position higher than the main tank body 2 so as to be communicated with the main tank body 2 without a water pump, and a rinsing liquid supplement valve 12 is used to control the flow of the supplemented rinsing liquid to ensure that the liquid level in the main tank body 2 is kept at a rinsing operation liquid level or maintain spillover. In such a case, the spillover slot 1 and the discharge port 6 are further connected to the rinsing liquid storage slot 9 respectively via a first water pump 11 and a second water pump 13. Of course, the rinsing liquid storage slot 9 can be disposed at a position lower than the main tank body 2 and further the supplement of rinsing liquid is realized by means of water pumps.

Further, the main tank body 2 can be provided therein with a heater 3 to maintain the temperature of the rinsing liquid in the main tank body 2, especially maintain the rinsing liquid at a temperature (generally 40° C. to 60° C.) where main ingredients of detergent are active. Moreover, the main tank body 2 can be provided therein with a bubbling valve 5 to form a large number of small bubbles in the rinsing liquid during the rinsing process of the display panel in such a way to enhance cleaning efficiency (because of micro explosion of small bubbles when touching the surface of the display panel).

The discharge port 6 shown in FIG. 2 may comprise a movable sealing plate linked to a jacking cylinder 8 to realize the opening and closing of the discharge port 6. Further, the discharge port 6 may be further communicated with the second filter 14 via the discharge water pump 13 to increase the discharge efficiency of rinsing liquid.

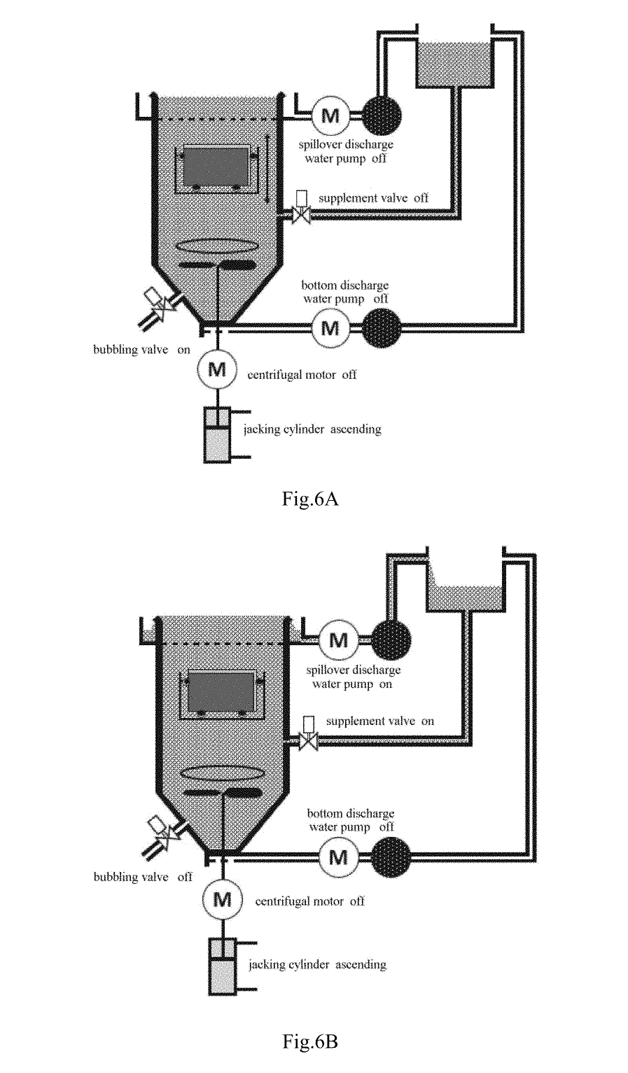

As shown in FIG. 2, the main tank body 2 may have a substantially cylindrical shape and a tapered shape at the bottom to facilitate collection of impurities. And as shown in FIG. 4, the upper edges of the main tank body 2 can be entirely curved towards the outside, namely, its opening is shaped like an outwards curved arc, so as to facilitate spillover of the rinsing liquid. Further, the upper edges are entirely at the same horizontal level, such that the rinsing liquid overflows uniformly in all directions and the fluctuation of foreign matters floating on the liquid surface can be eliminated.

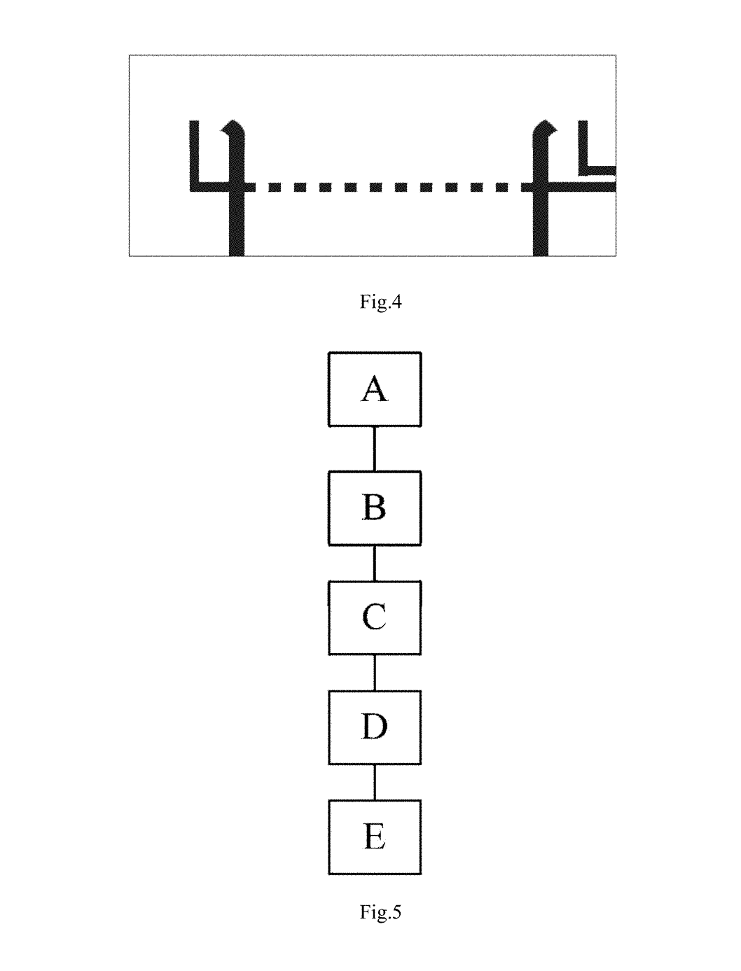

Generally, the process of cleaning a display panel may comprise the steps of feeding, entering into a rinsing tank, entering into a showering tank, entering into a clean water tank, entering into a dewatering tank, subjecting to drying and discharging. FIG. 3 shows the process of rinsing a display panel in the main tank body of the rinsing machine according to an embodiment of the present application. During the rinsing process of a display panel, first the rinsing liquid 31 is added into the main tank body 2. Then the display panel 35 is placed into a washing basket 33, and is secured by a securing support strip 34. Next, immersing the washing basket 33 into the rinsing liquid 31 in the main tank body 2, and removing the impurities on the display panel by means of the scouring effect caused by the movement of the washing basket and the bottom-up flow of the rinsing liquid. The flow direction of the rinsing liquid is shown by a dashed arrow 32 in FIG. 3. The moving direction of the washing basket 33 in the rinsing liquid is shown by a solid arrow 36.

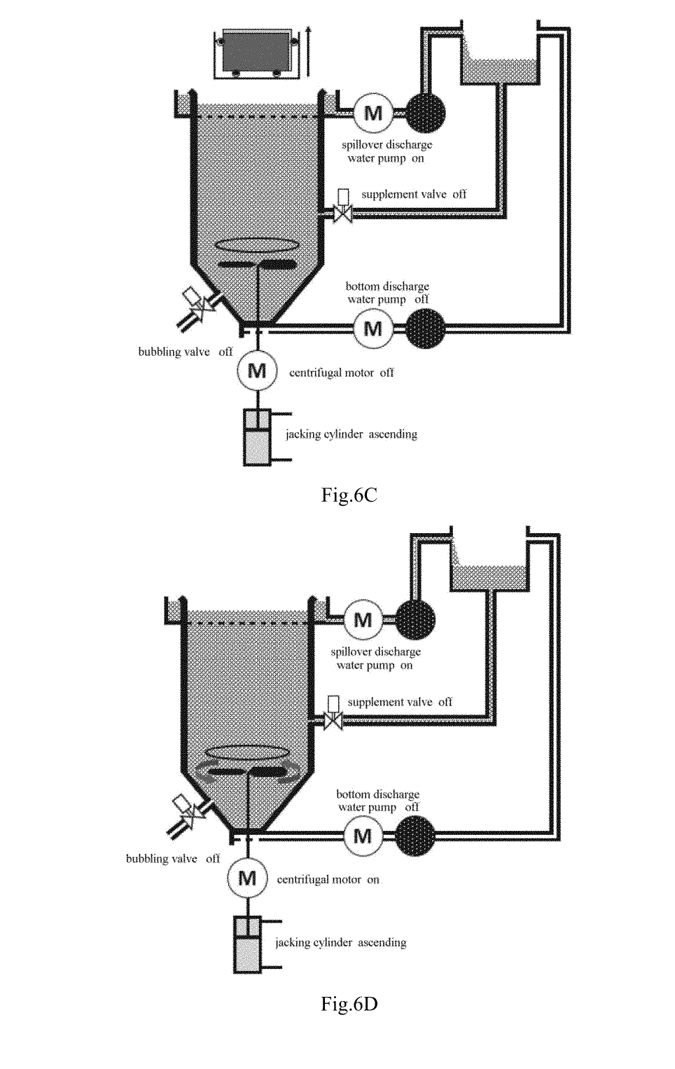

FIG. 5 shows a schematic working flowchart of the rinsing machine according to an embodiment of the present application. The working process comprises the following steps.

In Step A, placing a display panel into a rinsing liquid in a main tank body by means of a movement mechanism for the sake of rinsing. The display panel first may be inserted into the washing basket, so as to complete the rinsing by means of the up-and-down movement of the washing basket driven by the movement mechanism. In addition, prior to rinsing, the heater can be used to maintain the rinsing liquid at an active temperature, and during the rinsing process, the bubbling valve may be turned on.

In step B, after rinsing, keeping the display panel immersed in the rinsing liquid, and turning on a rinsing liquid supplement valve so that the rinsing liquid near the liquid surface overflows into a spillover slot via the upper edges of the main tank body. When the rinsing is finished, the movement mechanism is stopped, and the bubbling valve is turned off before turning on the rinsing liquid supplement valve. Moreover, the rinsing liquid in the main tank body is kept standing for a time period so that the surface of the rinsing liquid becomes still. The time period may last about 20 seconds. In the spillover process, impurities floating on the liquid surface will flow into the spillover slot, by which an effect of still standing for spillover is achieved.

In step C, turning off the rinsing liquid supplement valve, and taking the display panel away from the rinsing machine by the movement mechanism. The impurities floating on the liquid surface have been discharged in the Step B, so it will not occur that the impurities floating on the liquid surface are attached to the display panel in the step C of lifting the display panel away from the rinsing machine.

In step D, activating a stirrer to drive the rinsing liquid in centrifugal rotation for a certain time period, and then turning off the stirrer. Since some suspended impurities may exist in the rinsing liquid after the rinsing of the display panel, the stirrer can be activated after rinsing to facilitate the formation of suspended impurities having a density close to the rinsing liquid into pellet-like impurity precipitates by taking solid impurities as coagulation nuclei, and to enable solid matters, such as glass splinters, having a density larger than the rinsing liquid to rapidly precipitate at the bottom of the main tank body 2. After the centrifugal rotation, the rinsing machine may rest for a time period to let the impurities fully precipitate.

In step E, opening the discharge port to partially discharge the rinsing liquid at the bottom of the main tank body, and then closing the discharge port. The discharging process can be further realized by a water pump. In this way, the impurities precipitated at the bottom of the main tank body 2 can be rapidly discharged.

After the above steps, the purification of the rinsing liquid in the main tank body has been finished. In order to prepare the rinsing machine for the next rinsing, the supplement valve can be turned on to further supplement the rinsing liquid in the main tank body. Further, the discharged rinsing liquid can be reused after being filtered by a particular filter.

It can thus be seen that the rinsing machine according to the embodiment of the present invention can effectively remove impurities with some rinsing liquid recycling, greatly reduce the amount of circulated rinsing liquid and significantly decrease the power consumption.

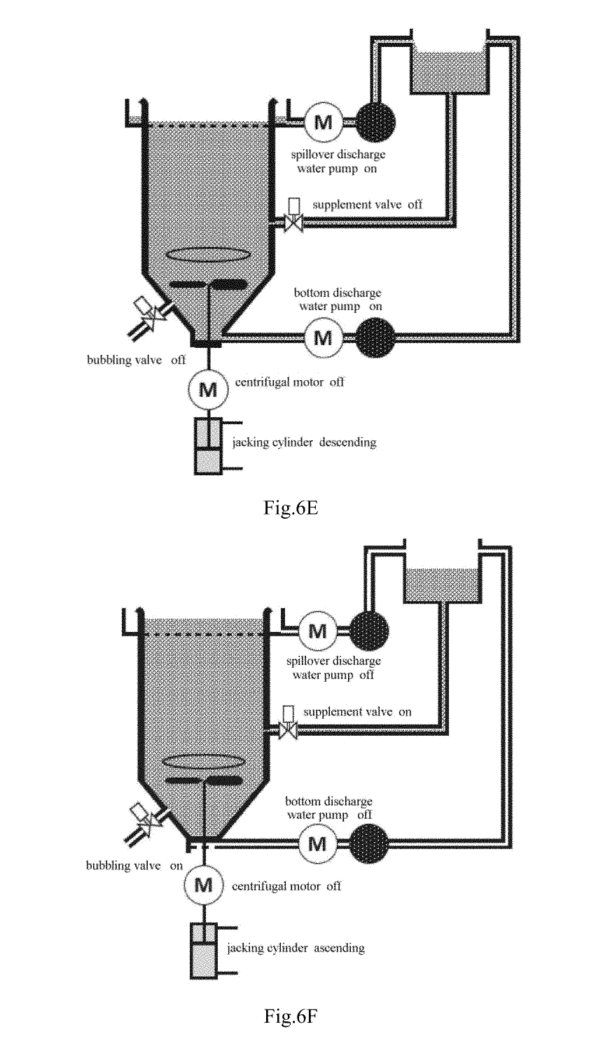

FIGS. 6A to 6F show the status of the rinsing machine in FIG. 2 at various working stages.

FIG. 6A shows the status when the display panel is rinsed. The main tank body is fully filled with the rinsing liquid, and the first water pump (a spillover discharge water pump), the second water pump (a bottom discharge water pump) and the supplement valve are turned off, the centrifugal motor (i.e., the motor 7) is stopped, and the jacking cylinder rises to close the discharge port. The panel to be rinsed is placed into the main tank body for rinsing and meanwhile the bubbling valve is turned on.

FIG. 6B shows the status of still standing for spillover. After rinsing, the panel is kept immovable in the rinsing liquid, the supplement valve is turned on and the bubbling valve is turned off, so that the rinsing liquid overflows into the spillover slot. Then, the spillover discharge water pump is turned on, so that the rinsing liquid in the spillover slot can flow into the storage slot after being filtered.

FIG. 6C shows the status after the panel is taken away. When the spillover is done, the supplement valve is turned off, and the display panel is taken away from the rinsing machine.

FIG. 6D shows the working status at the time of rotary stirring. After the panel is taken away, the centrifugal motor is started, namely the stirrer is initiated, to conduct stirring for separation of suspended impurities from the rinsing liquid. After stirring, the rinsing liquid is kept still standing for a time period to make impurities fully precipitated.

FIG. 6E shows the status when impurities are discharged via the bottom. The jacking cylinder descends to open the discharge port, and meanwhile the bottom discharge water pump can be turned on to discharge impurities at the bottom. The discharged rinsing liquid is conveyed to the storage slot after being filtered.

FIG. 6F shows the working status when the rinsing liquid is supplemented for the next rinsing. The jacking cylinder ascends, the bottom discharge port is closed, and the supplement valve is turned on.

Some embodiments of the present application are described above, but the scope of the present application is not so limited. Any variations or replacements readily envisaged by those skilled in the art without departing the spirit of the present application shall fall within the scope of the present application. Hence, the scope of the present application shall be based on the scope of the appended claims.

In the description of the present application, it shall be understood that orientation or positional relationship indicated by the terms such as “up”, “down”, “in” and “out” are discussed with reference to the drawings and merely for easy and simplified description of the embodiments of the present application, rather than indicate or imply that a device or element must have a particular orientation or be configured or operated in a particular orientation, and therefore shall not be deemed as a limitation to the present application. The word “comprises” or “comprising” does not exclude other elements or steps than those stated in the claims, and the indefinite article “a” or “an” preceding an element does not exclude a plurality. The mere fact that certain measures are recited in mutually different dependent claims does not indicate that a combination of these measures cannot be used to advantage. Any reference numeral in the claims shall not be interpreted as a limitation to the scope thereof.

1. A rinsing machine for cleaning a display panel, comprising: a main tank body, a spillover slot at the periphery of upper edges of the main tank body, a stirrer in the main tank body, and a rinsing liquid storage slot for storing rinsing liquid used for supplementing the rinsing liquid in the main tank body,
wherein the rinsing liquid storage slot is communicated with the main tank body via a rinsing liquid supplement valve, and
wherein the main tank body is provided with a discharge port which is capable of being opened and closed at the bottom of the main tank body.

2. The rinsing machine according to claim 1, wherein the spillover slot is communicated with the rinsing liquid storage slot via a first filter, and the discharge port is communicated with the rinsing liquid storage slot via a second filter.

3. The rinsing machine according to claim 2, wherein the rinsing liquid storage slot is disposed at a position higher than the main tank body, the spillover slot is communicated with the rinsing liquid storage slot via a first water pump, and the discharge port is communicated with the rinsing liquid storage slot via a second water pump.

4. The rinsing machine according to claim 2, wherein the first filter and the second filter are respectively provided with a polyethersulfone (PES) filtering element, and the filtering element in the first filter has a pore diameter smaller than that of the filtering element in the second filter.

5. The rinsing machine according to claim 4, wherein the filtering element in the first filter has a pore diameter ranging from 1 μm to 1.5 μm, and the filtering element in the second filter has a pore diameter ranging from 5 μm to 10 μm.

6. The rinsing machine according to claim 1, wherein the upper edges of the main tank body are at the same horizontal level, and each side of the upper edges is curved towards the outside of the main tank body.

7. The rinsing machine according to claim 1, wherein the main tank body is provided with a heater.

8. The rinsing machine according to claim 1, wherein the stirrer is driven by a motor below the main tank body.

9. The rinsing machine according to claim 1, wherein the main tank body is provided at its bottom with a cylinder-driven sealing plate for sealing the discharge port.

10. The rinsing machine according to claim 1, wherein the rinsing machine is provided with a bubbling valve.

11. The rinsing machine according to claim 1, wherein the bottom of the main tank body has a tapered shape.

12. A method for rinsing a display panel by a rinsing machine, wherein the rising machine comprises a main tank body, a spillover slot at the periphery of upper edges of the main tank body, a stirrer in the main tank body, and a rinsing liquid storage slot for storing rinsing liquid used for supplementing the rinsing liquid in the main tank body,
wherein the rinsing liquid storage slot is communicated with the main tank body via a rinsing liquid supplement valve, and
wherein the main tank body is provided with a discharge port which is capable of being opened and closed at the bottom of the main tank body;
the method comprising the steps of:
a) placing the display panel into the rinsing liquid in the main tank body by means of a movement mechanism for the sake of rinsing;
b) after rinsing, keeping the display panel immersed in the rinsing liquid, and turning on the rinsing liquid supplement valve so that the rinsing liquid near a liquid surface of the main tank body overflows into the spillover slot via the upper edges of the main tank body;
c) turning off the rinsing liquid supplement valve, and lifting the display panel by the movement mechanism away from the main tank body;
d) activating the stirrer to drive the rinsing liquid in centrifugal rotation for a certain time period, and then turning off the stirrer; and
e) opening the discharge port to at least partially discharge the rinsing liquid at the bottom of the main tank body, and then closing the discharge port.

13. The method according to claim 12, wherein the method further comprises a step of keeping the rinsing liquid in the main tank body still standing for a time period after rinsing and before turning on the rinsing liquid supplement valve.

14. The method according to claim 12, wherein the method further comprises a step of enabling the rinsing liquid in the spillover slot to flow into the rinsing liquid storage slot via a first filter and enabling the rinsing liquid discharged via the discharge port to flow into the rinsing liquid storage slot via a second filter.

15. The method according to claim 12, wherein the method further comprises a step of supplementing the rinsing liquid in the main tank body after the step e).

16. The method according to claim 12, wherein the spillover slot is communicated with the rinsing liquid storage slot via a first filter, and the discharge port is communicated with the rinsing liquid storage slot via a second filter.

17. The method according to claim 16, wherein the rinsing liquid storage slot is disposed at a position higher than the main tank body, the spillover slot is communicated with the rinsing liquid storage slot via a first water pump, and the discharge port is communicated with the rinsing liquid storage slot via a second water pump.

18. The method according to claim 16, wherein the first filter and the second filter are respectively provided with a polyethersulfone (PES) filtering element, and the filtering element in the first filter has a pore diameter smaller than that of the filtering element in the second filter.

19. The method according to claim 18, wherein the filtering element in the first filter has a pore diameter ranging from 1 μm to 1.5 μm, and the filtering element in the second filter has a pore diameter ranging from 5 μm to 10 μm.

20. The method according to claim 12, wherein the upper edges of the main tank body are at the same horizontal level, and each side of the upper edges is curved towards the outside of the main tank body.
